(19) United States
(12) Patent Application Publication
(10) Pub. No.: US 2011/0011532 A1
(43) Pub. Date: Jan. 20, 2011

(54) METHOD OF PRODUCING A ZIPPER PACK

(75) Inventor: Chel-Jong Song, Kunpo-shi (KR)

Correspondence Address: Hyun Jong Park;Park & Associates Intellectual Property Law LLC, Suite 106, 265 Bic Drive, Milford, CT, 06461, US

(73) Assignee: New Pack Korea Co., Ltd., Anyang-Shi (KR)

(21) Appl. No.: 12/891,086

(22) Filed: Sep. 27, 2010

Related U.S. Application Data
(62) Division of application No. 10/548,268, filed on Sep. 7, 2005.

(30) Foreign Application Priority Data
Jul. 10, 2003 (KR) 10-2003-0046661

(51) Int. Cl. B32B 37/00

(52) U.S. Cl. 156/289

(57) ABSTRACT

A method of producing a zipper pack includes the steps of: (a) providing a container having a front sheet member and a back sheet member, and a synthetic resin zipper with first and second wings extending substantially asymmetrically from the synthetic zipper; (b) inserting the synthetic resin zipper at a slanted angle to an interior surface of an opening part of the front and back sheet members of the container in such a manner that the substantially asymmetrically extending wings are arranged towards a corner area of the opening part of the container; (c) inserting an adhering prevention member between the first and second wings; (d) thermally adhering the first and second wings to the front and back sheet members of the container while having the adhering prevention member inserted between the first and second wings so as to prevent a thermal adhesion between the first and second wings; and (e) sealing outer edge portions of the front and back sheet members of the container.

### REFERENCE TO RELATED APPLICATIONS

This is a divisional application of U.S. patent application Ser. No. 10/548,268 filed on Sep. 7, 2005, which is a U.S. national phase application of International Patent Application PCT/KR2004/001567 filed on Jun. 28, 2004, which designates the United States and claims priority of Korean Patent Application No. 10-2003-0046661 filed on Jul. 10, 2003, the entire contents of which are incorporated herein by reference.

### FIELD OF THE INVENTION

The present invention relates to a corner open type zipper pack capable of achieving an automatic fabrication in which an opening part formed of a synthetic resin zipper is provided at a corner of a pack formed of a synthetic resin sheet source material, and in particular to an improvement to a structure of a zipper pack disclosed in the Korean patent No. 385472 in order to facilitate fabricating a zipper pack in a mass production base.

### BACKGROUND OF THE INVENTION

The above Korean patent No. 385472 was invented by the inventor of the present invention. In the above patent, a synthetic resin zipper is formed with male and female parts in an opening part at one corner portion of a pack.

In the above-identified pack of the patent, since a synthetic resin zipper thermally adhered to an opening part of the corner part is slanted, in a conventional fabrication line in which a zipper pack fabricated using a synthetic resin sheet source material is automatically fabricated, it is impossible to achieve a mass production.

For example, as shown in FIG. 6, in the case utilizing a conventional automatic fabrication line for a zipper pack, when a synthetic resin zipper 200 formed of two thermal adhering wings 211, 212, 221 and 222 in female and male zippers 210 and 220 is thermally adhered at an opening part 101 of a conventional zipper pack 100 as shown in FIG. 5 in a horizontally-disposed line shape, an automatic fabrication is possible. However, in the structure that the synthetic resin zipper 200 is thermally adhered at a certain slanted angle at a corner of one side of the opening part 101, an automatic fabrication is impossible. In addition, a defect ratio is increased.

Namely, since the synthetic resin zipper 200 is inserted into the interior of the opening part 101 of the zipper pack 100 and is thermally adhered in a state that the female and male zippers 210 and 220 are engaged, a thermal adhering prevention member should be placed between the thermal adhering wings formed at both sides of the female and male zippers 210 and 220 for preventing a thermal adhering phenomenon between the thermal adhering wings. When the synthetic resin zipper 200 is thermally adhered in a horizontal line shape in the same direction as the direction that the sheet source material of the zipper pack is arranged, the thermal adhering prevention member may be placed between the sheet source materials of the upper and lower sides. However, in the case that the synthetic resin zipper 200 is thermally adhered at the corner portion of one side of the opening part 101 at a slanted angle, it is impossible to place the thermal adhering prevention member for the reasons that the thermal adhering prevention member positioned in the moving direction of the synthetic resin zipper (which was thermally adhered to the sheet source material) interferes with the movement of the synthetic resin zipper.

In addition, the thermal adhering prevention member may be inserted into the interior of the opening part together with the synthetic resin zipper and then may be escaped therefrom. However, the above construction is not currently achieved by the current technology.

### SUMMARY OF THE INVENTION

Accordingly, it is an object of the present invention to provide a corner open type zipper pack capable of achieving an automatic fabrication that overcomes the problems encountered in the conventional art.

It is another object of the present invention to provide a corner open type zipper pack capable of producing by a mass production using a conventional automatic fabrication line in which a synthetic resin zipper is to be thermally adhered to an opened part of the zipper pack.

To achieve the above objects, in a zipper pack in which upper, lower, left and right edge portions of the front and back sheet members formed of a synthetic resin sheet source material are sealed by a thermal adhering method, and a synthetic resin zipper formed with female and male zippers is thermally adhered at a slanted angle to an inner side of an opening part at the corner portion of one side of upper end. The corner open type zipper pack comprises a synthetic resin zipper thermally adhered only at one side of each of the female zipper and the male zipper with a thermal adhering wing, wherein the female and male zippers are arranged in an inner direction of the zipper pack, and the thermal adhering wing is arranged in a direction towards the corner portion of the opening part to achieve a thermal adhering structure, so that an automatic fabrication is obtained.

### BRIEF DESCRIPTION OF THE DRAWINGS

The present invention will become better understood with reference to the accompanying drawings which are given only by way of illustration and thus are not limitative of the present invention, wherein;

FIG. 1 is a front view illustrating a zipper pack for describing the present invention;

FIG. 2 is a cross sectional view taken along the line A-A of FIG. 1;

FIG. 3 is a perspective view illustrating a synthetic resin zipper which will be thermally adhered to a corner of a zipper pack according to the present invention;

FIG. 4 is a view illustrating a fabrication process for an automatic fabrication of a zipper pack according to the present invention;

FIG. 5 is a front view illustrating a conventional zipper pack; and

FIG. 6 is an enlarged cross sectional view illustrating a separated state of a synthetic resin used for a conventional zipper pack.

### DETAILED DESCRIPTION OF THE INVENTION

The preferred embodiment of the present invention will be described with reference to the accompanying drawings.

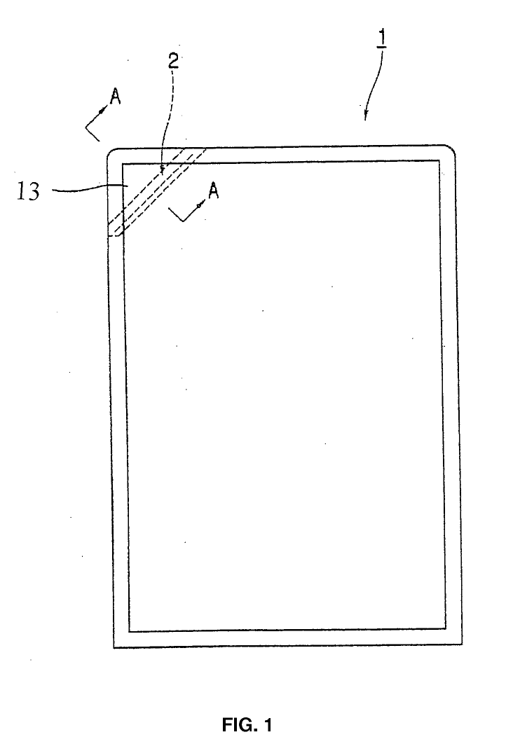

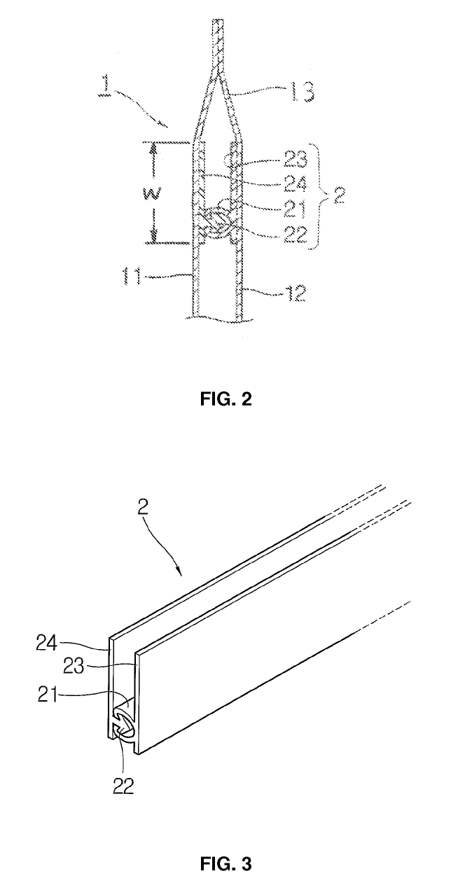

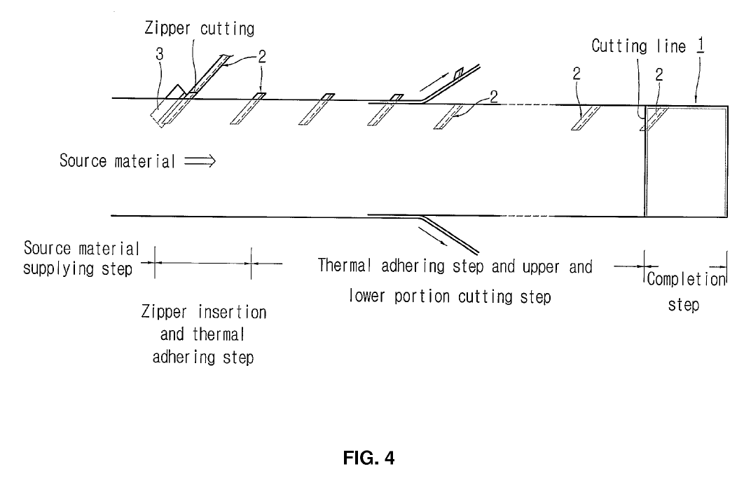

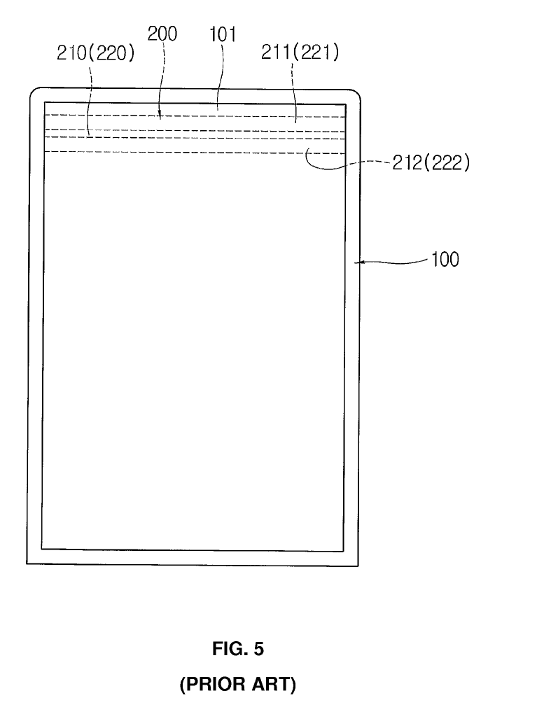

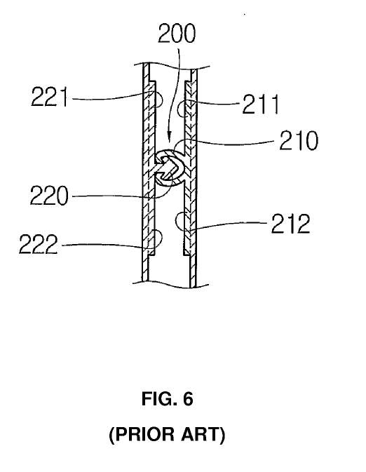

FIG. 1 is a front view illustrating a zipper pack for describing the present invention, FIG. 2 is a cross sectional view taken along the line A-A of FIG. 1, FIG. 3 is a perspective view illustrating a synthetic resin zipper to be thermally adhered to a corner of a zipper pack according to the present invention, and FIG. 4 is a view illustrating a fabrication process for an automatic fabrication of a zipper pack according to the present invention.

As shown therein, reference numeral 1 represents a zipper pack. The zipper pack 1 is formed of a synthetic resin sheet source material and is constructed in such a manner that the front sheet member 11 and the back sheet member 12 are overlapping each other, and the upper, lower, left and right side edges are thermally adhered in a certain width. An opening part 13 is formed in an inner side of the corner portion of one upper side in such a manner that the synthetic resin zipper 2 is thermally adhered to the zipper pack 1.

The synthetic resin zipper 2 is formed in such a manner that the female zipper 21 having an engaging groove and the male zipper 22 having an engaging protrusion are detachably engaged with each other.

The synthetic resin zipper is continuously thermally adhered at the opening part 13 of the zipper pack 1 through an automatic process.

In the present invention, the thermal adhering wings 23 and 24 each preferably have a same width “w” and are formed substantially asymmetrically and laterally towards the corner opening part 13 (as shown in FIGS. 1 and 2) from the center line of the female and male zippers 21 and 22, respectively, of the synthetic resin zipper 2. When thermally adhering the female and male zippers 21 and 22 at both inner surfaces of the opening part 13, the thermal adhering wings 23 and 24 are arranged towards the outer direction of the zipper pack 1, namely, the direction of the corner of the opening part 13. In this manner the female and male zippers 21 and 22 are arranged towards the inner side of the zipper pack, and the thermal adhering wings 23 and 24 are thermally adhered to both inner surfaces of the opening part 13, so that the zipper pack 1 of the present invention is automatically fabricated by mass production using a conventional automatic zipper fabrication line.

FIG. 4 is a view illustrating a step-by-step fabrication line for fabricating the zipper pack 1 according to the present invention. As shown therein, the fabrication process is implemented by the steps of: the source material supplying step→the zipper insertion and thermal adhering step→the edge portion thermal adhering step and upper and lower portion cutting step→the completion step, wherein the above steps are performed progressively from the source material supplying step. In the zipper insertion step and the thermal adhering step, the synthetic resin zipper 2 is intermittently supplied and placed to a certain length in the diagonal direction toward the portion between the front sheet member 11 of the upper side and the back sheet member 12 of the lower side. The synthetic resin zipper 2 is inserted such that the female and male zippers 21 and 22 are engaged with each other and in a state that the thermal adhering wings 23 and 24 are positioned towards the upper side as shown in the drawings.

The thermal adhering prevention member 3 (shown in FIG. 4) is placed between the thermal adhering wings 23 and 24 of the synthetic resin zipper 2, which is inserted in the diagonal direction, wherein the thermal adhering prevention member 3 prevents the thermal adhering wings 23 and 24 from being thermally adhered with each other when the synthetic resin zipper 2 is inserted. A thermal adhering apparatus is installed in the upper and lower sides of the source material in which the synthetic resin zipper 2 is inserted, namely, in the upper side of the front sheet member 11 and the lower side of the back sheet member 12 for thermally adhering the thermal adhering wings 23 and 24 to the front sheet member 11 and the back sheet member 12, respectively. After the thermal adhering wings 23 and 24 of the synthetic resin zipper 2 are thermally adhered to the front sheet 11 and the back sheet member 12 by the thermal adhering apparatus, the synthetic resin zipper 2 is cut by a cutting apparatus.

In the edge portion thermal adhering step and upper and lower portion cutting step, the edge portions of the source material thermally adhered with the synthetic resin zipper 2 are thermally adhered according to the design specification of the zipper pack 1, and the upper and lower portions are cut. In the completion step, the source material is cut according to the design specification of the zipper pack 1 to complete fabricating the zipper pack 1.

In the present invention, the thermal adhering wings 23 and 24 are formed at only one side of each of the female and male zippers 21 and 22 of the synthetic resin zipper 2 which is inserted into the open part 13 of the zipper pack 1 in the diagonal direction and thermally adhered therein. The female and male zippers 21 and 22 are positioned towards the inner side of the zipper pack 1, and the thermal adhering wings 23 and 24 are positioned towards the outer side of the zipper pack 1, so that it is possible to automatically fabricate the zipper pack 1 with the synthetic resin zipper 2 thermally adhered thereto.

As shown in FIG. 4, the thermal adhering prevention member 3 to be positioned between the thermal adhering wings 23 and 24 is placed in the rearward side of the female and male zippers 21 and 22 with respect to the moving direction of the source material, so that the source material can be transferred freely while the thermal adhering wings 23 and 24 of the synthetic resin zipper 2 are thermally adhered, and thus enabling an automatic fabrication of the zipper pack 1.

As described above, the synthetic resin zipper is thermally adhered at an inner side of the opening part formed at the corner portion of the zipper pack at a slanted angle. The female and male zippers of the synthetic resin zipper are arranged towards the inner direction of the zipper pack, while the thermal adhering wings formed only at one side of each of the female and male zippers are arranged towards the outer direction of the zipper pack. In this manner, the thermal adhering wings are thermally adhered while enabling an automatic fabrication of the zipper pack. Accordingly, the productivity of the zipper pack is enhanced, and the fabrication cost is decreased.

In addition, when the zipper pack according to the present invention is adapted to packing certain stuff such as sugar, taste salt, seasoning, coffee, wheat flour, mixture of grain powders, powder of pepper, rice, barley, powder or liquid cleaning materials, it is possible to re-seal the opening part after a certain amount of the stuff is discharged, thus enabling an effective storing of the stuff.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A method of producing a zipper pack comprising the steps of:
providing a container having a front sheet member and a back sheet member, and a synthetic resin zipper with first and second wings extending substantially asymmetrically from the synthetic zipper;
inserting the synthetic resin zipper at a slanted angle to an interior surface of an opening part of the front and back sheet members of the container in such a manner that the substantially asymmetrically extending wings are arranged towards a corner area of the opening part of the container;
inserting an adhering prevention member between the first and second wings;
thermally adhering the first and second wings to the front and back sheet members of the container while having the adhering prevention member inserted between the first and second wings so as to prevent a thermal adhesion between the first and second wings; and
sealing outer edge portions of the front and back sheet members of the container.

2. The method of claim 1, wherein the synthetic resin zipper includes female and male zipper portions resealably engaging to each other, and said thermally adhering step is performed while having the female and male zipper portions engaged with each other.

3. The method of claim 1, wherein the method is performed in an automatic fabrication line adapted to provide a source material of the container progressively, and as the adhering prevention member is inserted between the substantially asymmetrically extending wings, which are arranged towards the corner area of the container, the progressive flow of the source material is not interfered by the presence of the adhering prevention member.

4. The method of claim 3, further comprising cutting the source material after the sealing step to obtain an individual zipper pack of predetermined shape and size.

5. The method of claim 1, wherein the zipper pack has a rectangular shape.

6. The method of claim 1, wherein the first and second wings have a same width.
